(19) United States
(12) Patent Application Publication
(10) Pub. No.: US 2020/0296219 A1
(43) Pub. Date: Sep. 17, 2020

(54) MESSAGING FOR VOIP APPLICATION AND EXTERNAL APPARATUS

(71) Applicant: MICROSOFT TECHNOLOGY LICENSING, LLC, Redmond, WA (US)

(72) Inventors: Dasmit BAJAJ, Kirkland, WA (US); Tao HUANG, Bellevue, WA (US); Douglas R. ANDERSON, Redmond, WA (US); Sandhya RAO, Bellevue, WA (US); Prasad THIRUVEEDU, Redmond, WA (US)

(21) Appl. No.: 16/355,647

(22) Filed: Mar. 15, 2019

(51) Int. Cl. H04M 7/00; H04W 4/80; H04W 4/12; H04W 76/14

(52) U.S. Cl. CPC H04M 7/006; H04W 76/14; H04W 4/12; H04W 4/80

(57) ABSTRACT

A speakerphone and a computing device executing a voice over internet protocol (VoIP) communication application that provides communication session connectivity coupled via a direct communication channel provided by a wireless or wireline interconnection. The speakerphone and the VoIP communication application are configured with a messaging technology. The messaging technology allows the speakerphone and the VoIP communication application to exchange data, such as function data and information data.

### BACKGROUND

Technology exists that allows users to participate in audio/video communication sessions and other types of multi-user communication exchanges. Microsoft Skype (with Business and Consumer versions) and Microsoft Teams are examples of such technology offerings in the marketplace today.

Users typically participate in communication sessions through an application client running on a computing device. A familiar scenario might involve users engaging in a video conference with each other from their desks or individual work spaces via a client application running on their desktop computer, laptop computer, tablet, or mobile phone.

To engage in a communication session with others, a user may have to perform a series of user selections in order to join the communication session. For example, if the application client is not in the foreground as the active application client on the host computing device, the user might need to switch to the application client (or start and log in to the client application if it is not running) followed by one or more selections to find and join a desired conference. Such user interaction requires the user to have the computing device that is running the application client at hand and then manipulate the computing device in order to make the user interactions.

In a hands-free communication session scenario, a user may wish to have the audio of the other participants in the communication session broadcast from an external apparatus (e.g., speakerphone), which may be of a higher quality and allow for a greater volume than a speaker built into the device. The external apparatus may also capture the user's voice in order to send it to the other conference participants via the client application.

Visual or other types of notifications, controls and information may be displayed on the computing device via the client application. However, the computing device hosting the client application may not be readily available or in view when it is coupled to an external apparatus, and the conventional technologies do not provide techniques for controlling or invoking functions associated with the client application via the external apparatus.

At least the foregoing shows that there remains a technical need to provide improved external apparatuses, which couple to client applications and that provide communication session connectivity for users.

### SUMMARY

The technologies described herein address the technical need to provide improved external apparatuses that can couple to client applications that provide communication session connectivity. As described in the foregoing, conventional speakerphones do not have user controls that allow a user to control a voice over internet protocol (VoIP) communication application hosted by a computing device. For example, a conventional speakerphone does not have user controls or functionality that allows for dialing a phone number that is to be placed by the VoIP communications application, causes the VoIP application to mute an ongoing phone call, and the like.

Similarly, conventional speakerphones and VoIP communication applications do not have functionally the provides for the exchange of notifications, such as a when a call is being dialed by the VoIP communication application or when a call has been connected via the VoIP communication application.

The foregoing functional limitations of conventional speakerphones and VoIP communication applications are particularly problematic when a speakerphone and computing device hosting a VoIP communication application are not in close proximity or readily viewable, such as when such a hosting computing device is in a user's pocket, desk drawer, or the like.

The described implementations introduce a messaging technology that can remedy the deficiencies of conventional speakerphones and VoIP applications. The messaging technology, when integrated with speakerphones and VoIP applications, allow for the exchange of notifications, controlling and enabling of functions of the VoIP communication application via the speakerphone, relaying information, and the like.

In some implementations, a speakerphone and a computing device, executing a voice over internet protocol (VoIP) communication application that provides communication session connectivity, can couple via a direct communication channel provided by a wireless or wireline interconnection. The speakerphone and the VoIP communication application are configured with a messaging technology. The messaging technology allows the speakerphone and the VoIP communication application to exchange data, such as function data and information data.

In some implementations, the speakerphone uses the messaging technology to communicate a phone number to the VoIP communication application. The VoIP communication application may dial the phone number on behalf of the speakerphone.

The VoIP communication application may communicate status information related to the dialed phone number to the speakerphone using the messaging technology. For example, the status information may include information indicating that the phone number has been dialed, the phone number is ringing, a connection has been established, caller identification (ID) has been determined, and/or contact information (e g, name) linked to the telephone number has been identified.

The speakerphone may use the messaging technology to select functions provided by the VoIP communication application. For example, the speakerphone may be caused, via user input such as pressing a mute button on the speakerphone, to send a mute message to the VoIP communication application. The VoIP communication application may select a mute function in response to receiving the mute message. Furthermore, the VoIP communication application may use the messaging technology to communicate a confirmation that the VoIP communication application invoked the mute function associated therewith.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithm(s), hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates an exemplary communication session arrangement that includes an external apparatus and a computing device.

FIG. 2 illustrates operation of the exemplary communication session arrangement that includes when a user of the arrangement initiates dialing a telephone number using the external apparatus.

FIG. 3 illustrates operation of the exemplary communication session arrangement that includes when a phone call is connected to the external apparatus via the computing device.

FIG. 4 illustrates operation of the exemplary communication session arrangement that includes when a phone call is incoming at the computing device and the computing device is coupled to the external apparatus.

FIG. 5 illustrates operation of the exemplary communication session arrangement that includes when a phone call is incoming at the computing device and the phone call is answered via the external device.

FIG. 6 illustrates operation of the exemplary communication session arrangement that includes when a phone call is ongoing, and the phone call is muted via the external apparatus.

FIG. 7 is a diagram illustrating aspects of a routine related to messaging communications exchanged between an external apparatus and a computing device.

FIG. 8 is a diagram illustrating aspects of another routine related to messaging communications exchanged between an external apparatus and a computing device.

FIG. 9 is a computer architecture diagram showing an illustrative computer hardware and software architecture for a computing device that can implement the various technologies presented herein.

FIG. 10 is a network diagram illustrating a network computing environment 1000 in which aspects of the disclosed technologies can be implemented, according to various embodiments presented herein.

### DETAILED DESCRIPTION

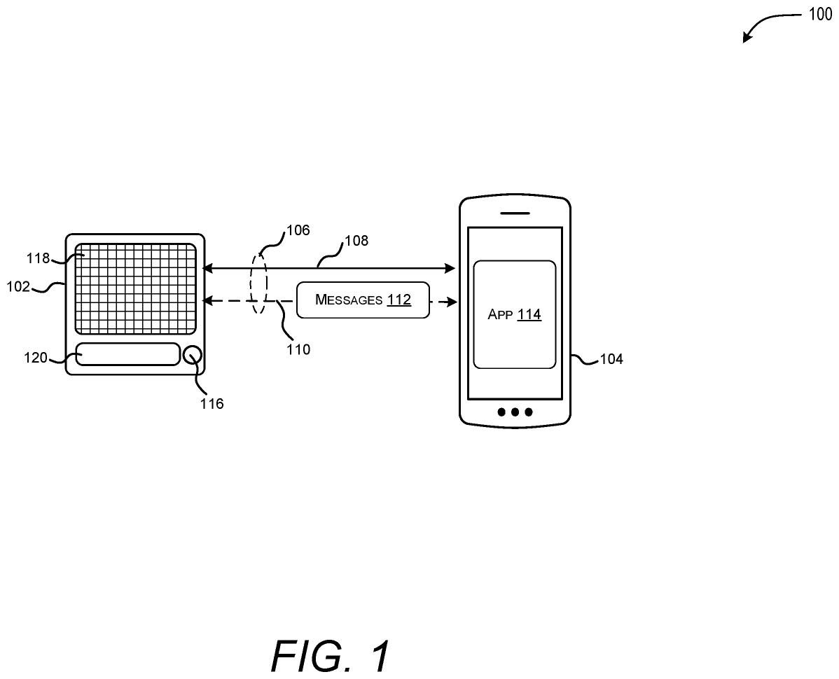

FIG. 1 illustrates an exemplary communication session arrangement 100 that includes an external apparatus 102 and a computing device 104. In some implementations, the external apparatus 102 is a speakerphone and the computing device 104 is a mobile phone. In other implementations, the external apparatus 102 is a headset. The external apparatus 102 may include at least a microphone 116, speaker 118, and indicator/button 120. The indicator/button 120 may initiate or establish a connection with the computing device 104 and one or more applications hosted thereby. Furthermore, the indicator/button 120 may display or show (e.g., using LED(s)) that a connection with the device is active, connecting, muted, or the like. The LED(s) may change colors to indicate various connection states between the external apparatus 102 and the computing device 104 and/or applications hosted by the computing device 104.

The computing device 104, in some implementations, may be representative of a tablet, laptop, or any other suitable computing and/or communication device. And in general, the external apparatus 102 to may be representative of any apparatus that allows users to hear and speak to one or more participants associated with a communication session. For example, the actual apparatus 102 may be associated with a head unit in a vehicle or any other portion of the vehicle, a television, a television remote, and the like.

A communication medium 106 may be used to connect the computing device 104 to the external apparatus 102. In some implementations, the communication medium 106 includes a wireless interconnection medium that connects the computing device 104 to the external apparatus 102. The communication medium 106 may be implemented using a near field communications (NFC) protocol, a Bluetooth protocol, a Wi-Fi protocol, or another type of wireless protocol. Alternatively, the communication medium 106 may be implemented using a wireline interconnection medium, such as a universal serial bus (USB) cable, lightning cable, or the like.

In some implementations, the communication medium 106 comprises a wireless or wireline interconnection 108 that is automatically established between the external apparatus 102 and the computing device 104 based on wireless proximity or wireline connectivity between the external apparatus 102 and the computing device 104. Additionally, the communication medium 106 may comprise a communication channel 110 that is established after the interconnection 108 is negotiated between the external apparatus 102 and the computing device 104. In some implementations, the interconnection 108 is a Bluetooth interconnection between the external apparatus 102 and the computing device 104 and the communication channel 110 is a Bluetooth channel between the external apparatus 102 and the computing device 104.

The communication channel 110, in some implementations, is a direct communication channel between the external apparatus 102 and the computing device 104. Such a direct communication channel may be implemented by a personal area network (PAN) technology, such as Bluetooth, Wi-Fi direct, or ZigBee.

In some implementations, the direct communication channel between the external apparatus 102 and the computing device 104 is a dedicated, persistent and secure short-range (i.e., up to 100 m range and in some implementations up to 10 m) communication channel established between the external apparatus 102 and the computing device 104, which are in local proximity to each other. The dedicated, persistent and short-range characteristics of the direct communication channel between the external apparatus 102 and the computing device 104 is advantageous because it offers a very low communication latency between the external apparatus 102 and the computing device 104. The low latency characteristic of the direct communication channel means that messages exchanged between the external apparatus 102 and the computing device 104 are processed very quickly to achieve timely processing of the notifications and/or functions carried by messages 112.

Advantageously, security of the direct communication channel between the external apparatus 102 and the computing device 104 is achieved because the direct communication channel is established only after an authorization and authentication procedure negotiated between the external apparatus 102 and the computing device 104.

The low power consumption of the direct communication channel used between the external apparatus 102 and the computing device 104 is particularly advantageous when the implementation of the external apparatus 102 is a mobile computing device, such as a mobile phone. The low power consumption characteristics of the direct communication channel are achieved through the use of low powered wireless signals that carry data between the external apparatus 102 and the computing device 104 and the frequency hopping communication techniques associated with the direct communication channel.

The communication channel 110 may be a full-duplex direct communication channel that couples the external apparatus 102 and the computing device 104. Alternatively, the communication channel 110 may be a half-duplex direct communication channel between the external apparatus 102 and the computing device 104.

In some implementations, the external apparatus 102 and the computing device 104 are coupled together using a plurality of communication channels 110. Each of the priority of communication channels 110 may be direct communication channels between the external apparatus 102 and the computing device 104. It may be advantageous to implement a plurality of direct communication channels between the external apparatus 102 and the computing device 104 to support latency free or near latency free simultaneous communication of messages 112, call data (e.g., voice data), chat data, and the like, between the external apparatus 102 and the computing device 104.

The communication medium 106 may be used for exchanging data between the external apparatus 102 and the computing device 104. In some implementations, the data may include function information used by the external apparatus 102 and/or the computing device 104 to enable functional capabilities of the external apparatus 102 and/or the computing device 104 and applications hosted by the computing device 104. Furthermore, the data may include informational data generated by the external apparatus 102 and/or the computing device 104 to convey information associated with functional capabilities of the external apparatus 102 and the computing device 104.

In some implementations, the data exchanged between the external apparatus 102 and the computing device 104 is included in one or more messages 112. For example, a message 112 may convey a telephone number, email address, contact alias, or other contact information to the computing device 104. An application 114, such as a voice over Internet protocol (VoIP) communication application or other communication application, hosted and executed by the computing device 104 may use the contact information conveyed in the message 112 to initiate a communication session (e.g., voice communication session or a text based chat session) using a function of the application 114. In some implementations, the message 112 may convey caller identification (ID) information, contact information associated with the telephone number, or the like, to the external apparatus 102.

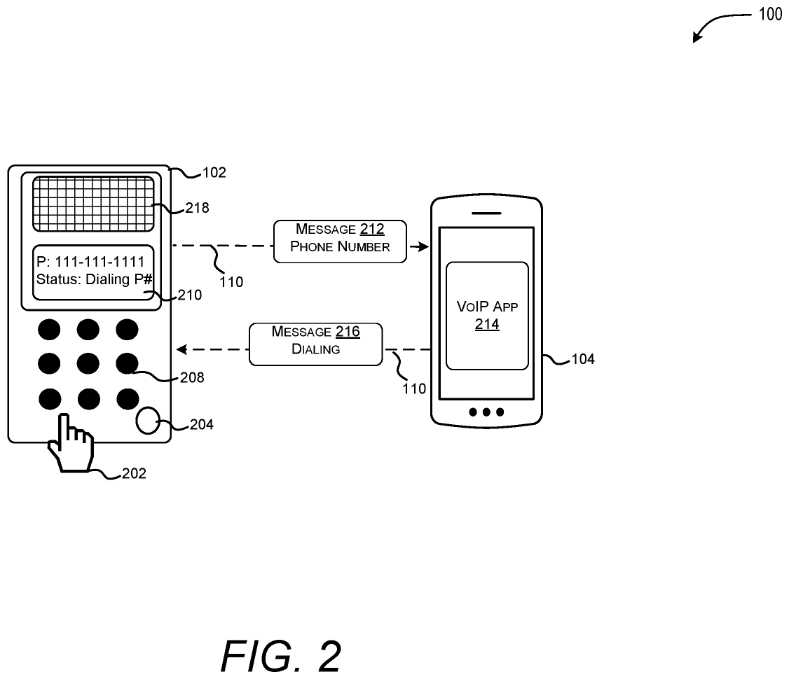

FIG. 2 illustrates operation of the exemplary communication session arrangement 100 that includes when a user 202 of the arrangement 100 initiates dialing a telephone number using the external apparatus 102. The operation assumes a wireless or wireline interconnection has already been established between the external apparatus 102 and the computing device 104. The interconnection, in some implementations, may be automatically established when the computing device 104 is in close proximity (e.g. 30 m) to the external apparatus 102. Alternatively, the interconnection may be established when the user 202 presses a button 204 on the external apparatus 102. The button 204 may be a hardware-based button or a user interface (UI) soft button. In yet another embodiment, the interconnection may be established when the computing device 104 is placed in a mobile phone dock (not illustrated) of the external apparatus 102. The mobile phone dock may detect the presence of the computing device 104 using electromagnetic induction.

The user 202 may dial a telephone number using a keypad 208. The dialed telephone number may be displayed on an indicator 210 of the external apparatus 102. The indicator 210 may be any suitable technology, such as a flat panel display, for displaying information that is readable by the user 202. Alternatively, the user 202 may dial the telephone number by speaking. The speech provided telephone number may be recognized by the external apparatus 102 with a speaker/microphone 218 of the external apparatus 102.

A controller (not illustrated in FIG. 1) or processor associated with the external apparatus 102 may include computer executable instructions to detect when the user 202 has dialed a telephone number using the keypad 208 or speaker/microphone 218. Those skilled in the art will appreciate that the controller of the external apparatus 102 and the associated computer executable instructions may perform other functions described herein.

In response to detecting the dialed telephone number, the external apparatus 102 generates a message 212 that includes the dialed telephone number. The message 212 including the dialed telephone number may be conveyed to the computing device 104 over the communication channel 110. For example, the message 212 may be communicated to a VoIP communication application 214 over the communication channel 110.

The VoIP communication application 214, using functionality associated therewith, uses the phone number received in the message 212 to attempt to connect to a user associated with the phone number. Furthermore, the VoIP communication application 214 may generate a message 216 that includes data linked to dialing the phone number received in the message 212. For example, the message 216 may include a status message indicating “dialing”. The message 216 may be communicated to the external apparatus 102 over the communication channel 110.

The external apparatus 102 may parse the message 216 to retrieve the status message “dialing”. The external apparatus 102 may update the indicator 210 to include the status message “dialing.”

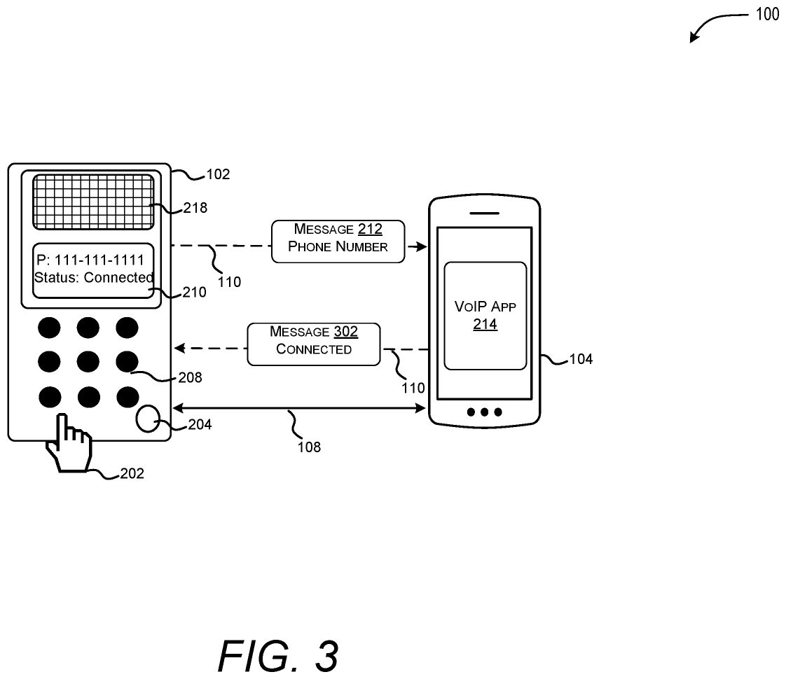

FIG. 3 illustrates operation of the exemplary communication session arrangement 100 that includes when a phone call is connected to the external apparatus via the computing device 104. The VoIP communication application 214, using functionality associated therewith, generates a message 302 that includes data linked to dialing the phone number received in the message 212 and connecting to a user associated with the phone number. For example, the message 302 may include a status message “connected”. The message 302 may be communicated to the external apparatus 102 over the communication channel 110.

The external apparatus 102 may parse the message 302 to retrieve the status message “connected”. The external apparatus 102 may update the indicator 210 to include the status message “connected.” The user 202 may conduct the call via the speaker/microphone 218 of the external apparatus 102. In particular, call data of the active phone call, such as voice data, is conveyed between the external apparatus 102 and the VoIP commutation application 214 using the interconnection 108. However, the call data of the active phone call, such as voice data, may be alternatively conveyed via the communication channel 110, or the call data may be conveyed over both the interconnection 108 and the communication channel 110.

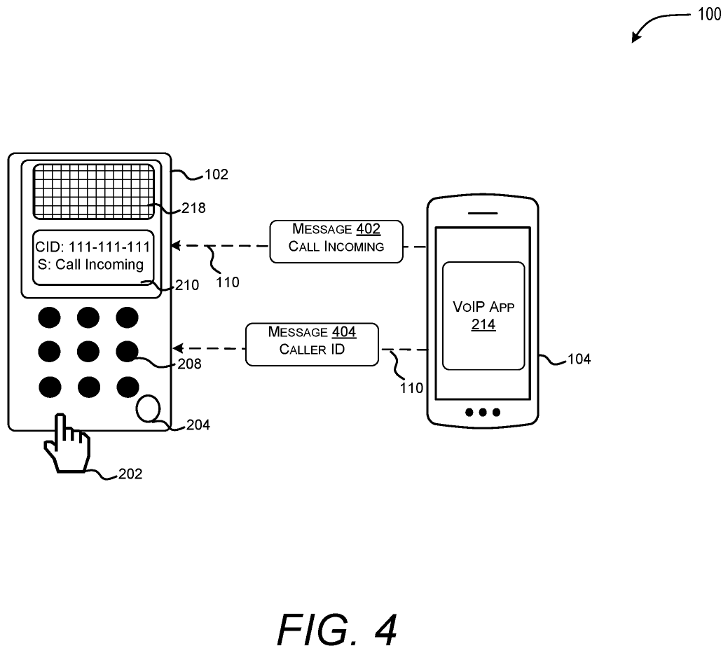

FIG. 4 illustrates operation of the exemplary communication session arrangement 100 that includes when a phone call is incoming at the computing device 104 and the computing device 104 is coupled to the external apparatus 102. In this arrangement, the external apparatus 102 has an ongoing interconnection, via at least the communication channel 110, with the VoIP communication application 214.

The VoIP communication application 214 generates a message 402 that includes the status data “call incoming”. The message 402 is communicated to the external apparatus 102 over the communication channel 110. The external apparatus 102 may use the status data associated with the message 402 to update the indicator 210 to display the status data “call incoming”.

The VoIP communication application 214 may also generate a message 404 to include caller ID information associated with the phone call that is incoming at the computing device 104. The caller ID information may include the telephone number associated with the telephone call that is incoming at the computing device 104, contact information (e.g. name, email address, and the like) linked to the telephone number and/or other information that may be linked to the telephone number. Some or all of the caller ID information may be stored in a storage (not illustrated on FIG. 4) of the computing device 104. Alternatively, some or all of the caller ID information may be automatically provided to the computing device 104 from one or more network based storage devices.

The message 404 is communicated to the external apparatus 102 over the communication channel 110. The external apparatus 102 may use the caller ID information associated with the message 404 to update the indicator 210 to display some or all of the caller ID information conveyed with the message 404.

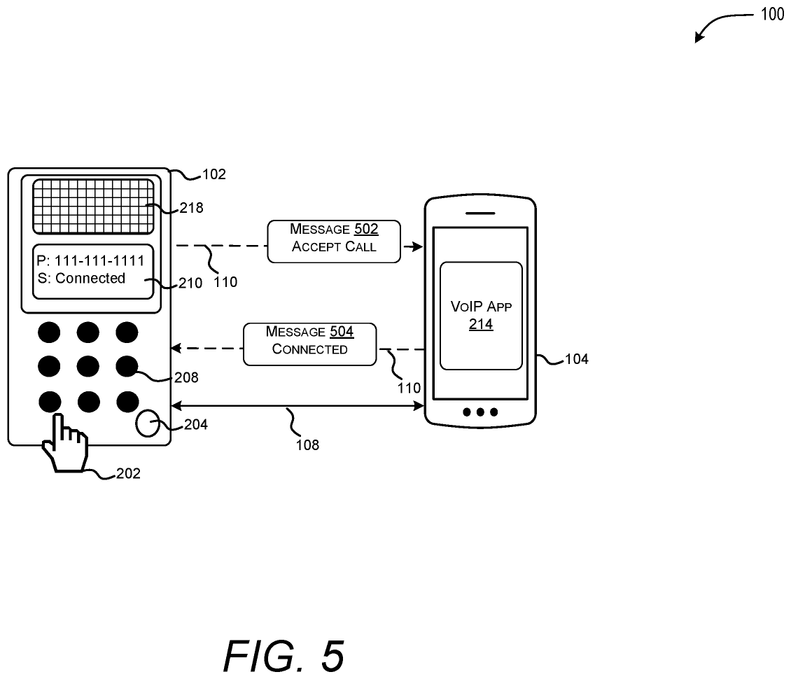

Continuing from FIG. 4, FIG. 5 illustrates operation of the exemplary communication session arrangement 100 that includes when a phone call is incoming at the computing device 104 and the phone call is answered via the external apparatus 102.

After the message 402, including the status data “call incoming”, is received by the external apparatus 102, the user 202 may accept the phone call by pressing the button 204 or providing a speech command that is received by the speaker/microphone 218. Action by the user 202 to accept the phone call may cause the external apparatus 102 to generate a message 502 that includes command data, such as “accept call”.

The message 502 is communicated to the computing device 104 over the communication channel 110. The VoIP communication application 214 interprets the command data of the message 502, accepts the incoming call, and generates a message 504 including the status data “connected”. The message 504 is communicated to the external apparatus 102. The external apparatus 102 may use the status data associated with the message 504 to update the indicator 210.

The interconnection 108 between the external apparatus 102 and the computing device 104 may be used to exchange speech or voice data associated with the accepted phone call by the VoIP communication application 214. However, the call data of the accepted phone call, such as voice data, may be alternatively conveyed via the communication channel 110, or the call data may be conveyed over both the interconnection 108 and the communication channel 110.

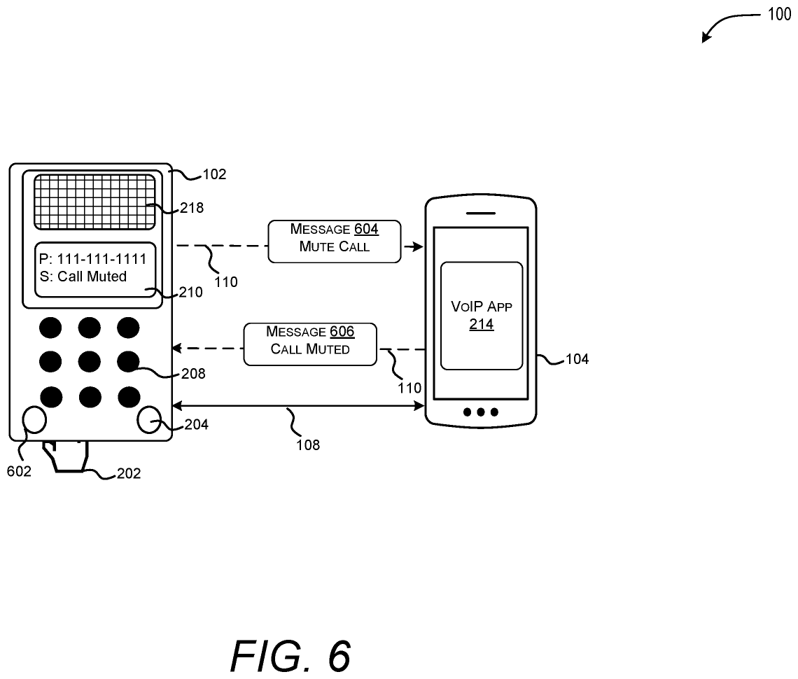

FIG. 6 illustrates operation of the exemplary communication session arrangement 100 that includes when a phone call is ongoing, and the phone call is muted via the external apparatus 102.

An ongoing phone call associated with the external device 102 and the VoIP communication application 214 may be muted by the user 202 by pressing a button 602 or by providing a speech command that is received by the speaker/microphone 218. Action by the user 202 to mute the phone call may cause the external apparatus 102 to generate a message 604 that includes command data, such as “mute call”. Furthermore, action by the user 202 to mute the phone call may cause the external apparatus 102 to disable the microphone associated with the microphone/speaker 218.

The message 604 is communicated to the computing device 104 over the communication channel 110. The VoIP communication application 214 interprets the command data of the message 604 and generates the message 606 including the status data “call muted”. Furthermore, in response to the message 604, the VoIP communication application 214 mutes the ongoing phone call. For example, the VoIP communication application 214 may mute the ongoing phone call by disabling communication of sound (voice) data, over the interconnection 108, to the external apparatus 102.

The message 606 is communicated to the external apparatus 102. The external apparatus 102 may use the status data associated with the message 606 to update the indicator 210. A similar messaging process to that illustrated in FIG. 6 may be used to unmute a muted phone call.

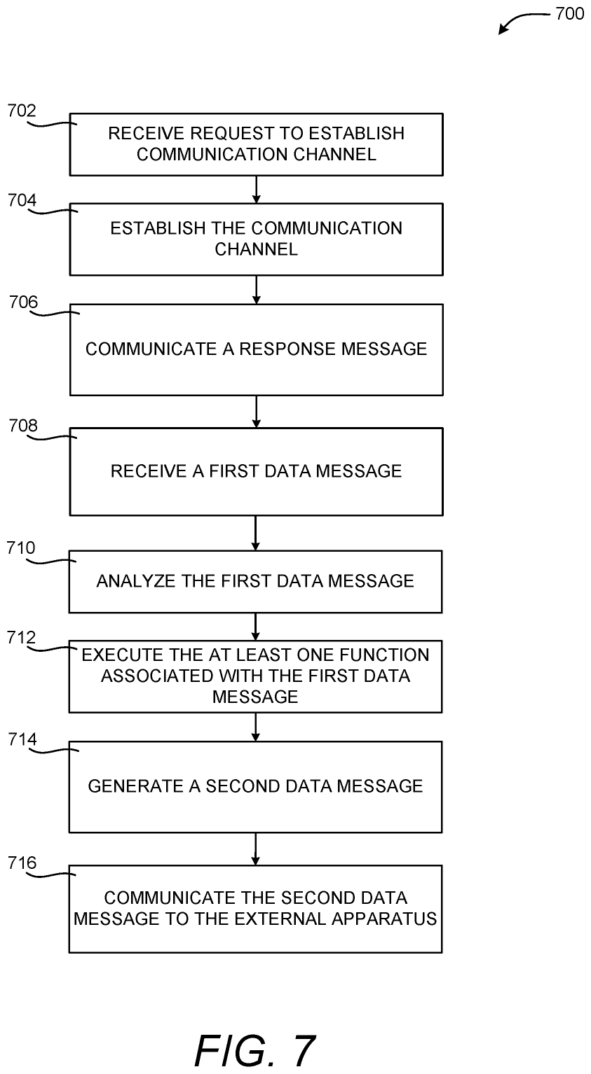

FIG. 7 is a diagram illustrating aspects of a routine 700 related to messaging communications exchanged between an external apparatus and a computing device. For example, the routine 700 may be executed by the external apparatus 102 and/or the computing device 104. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Additionally, the operations illustrated in FIG. 7 and the other FIGURES can be implemented in association with the example apparatuses and computing devices described herein.

The routine 700 begins at operation 702, where a request message from an external apparatus is received by a client computing device. In some implementations, the external apparatus is a speakerphone and the client computing device hosts a VoIP communication application. The request message may include a request to establish a communication channel. The request message may have been received over a wireless or wireline communication interconnection between the external apparatus and the client computing device hosting the VoIP communication application. In some implementations, the communication interconnection between the external apparatus and the client computing device is a Bluetooth interconnection.

At operation 704, the computing device hosting the VoIP communication application establishes the requested communication channel. In some implementations, the established communication channel is a Bluetooth communication channel associated with the Bluetooth interconnection between the external apparatus and the client computing device. The VoIP communication application may detect the communication channel after it is established by the computing device hosting the VoIP communication application.

At operation 706, the computing device hosting the VoIP communication application or the VoIP communication application responds to the request message by communicating a response message to the external apparatus. The response message includes a response approving the request to establish the communication channel. The response message may be communicated over the communication channel or the interconnection between the external apparatus and the client computing device.

At operation 708, the VoIP communication application receives a first data message from the external apparatus. The first data message is communicated over the communication channel. The first data message may include data to cause the VoIP communication application to invoke at least one function supported by the VoIP communication application. For example, the first data message may include one or more commands and/or data that cause the VoIP communication application to invoke a function associated with the application. In some implementations, the first data message includes a telephone number, a mute command, an answer phone call command, and the like.

At operation 710, the VoIP communication application analyzes the first data message and the data therein to identify the at least one function that is to be executed by the VoIP communication application.

At operation 712, the VoIP communication application executes the at least one function associated with the data of the first data message.

At operation 714, the VoIP communication application generates a second data message that includes data linked to the at least one function executed by the VoIP communication application. For example, the second data message may include data confirming execution of the at least one function. In particular, the second data message may include data confirming that the VoIP communication application is dialing the phone number, has established a phone call connection, muted an ongoing phone call connection, or the like.

At operation 716, the VoIP communication application communicates the second data message to the external apparatus.

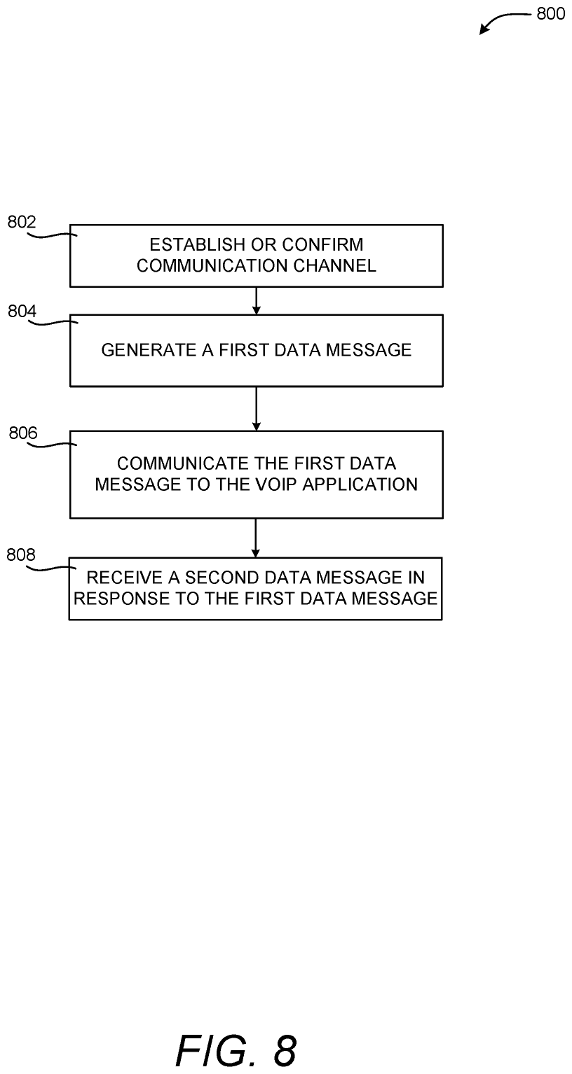

FIG. 8 is a diagram illustrating aspects of another routine 800 related to messaging communications exchanged between an external apparatus and a computing device. For example, the routine 800 may be executed by the external apparatus 102 and/or the computing device 104. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Additionally, the operations illustrated in FIG. 8 and the other FIGS. can be implemented in association with the example apparatuses and computing devices described herein.

The routine 800 begins at operation 802, where an external apparatus confirms or establishes a communication channel A similar process as described in relation to operations 702-704 may be used by the external apparatus and/or computing device hosting a VoIP communication application to establish the communication channel.

At operation 804, the external apparatus generates a first data message. The first data message may include data to cause a VoIP communication application to invoke at least one function supported by the VoIP communication application. For example, the first data message may include one or more commands and/or data that cause the VoIP communication application to invoke a function associated with the application. In some implementations, the first data message includes a telephone number, a mute command, an answer phone call command, and the like.

At operation 806, the external apparatus communicates the first data message to the VoIP communication application. The communication channel may be used to communicate the first data message to the VoIP communication application.

At operation 808, the external apparatus receives a second data message from the VoIP communication application. The second data message is communicated to the external apparatus in response to the first data message. In some implementations, the second data message includes data linked to the at least one function executed by the VoIP communication application. For example, the second data message may include data confirming execution of the at least one function. In particular, the second data message may include data confirming that the VoIP communication application is dialing the phone number, has established a phone call connection, muted an ongoing phone call connection, or the like.

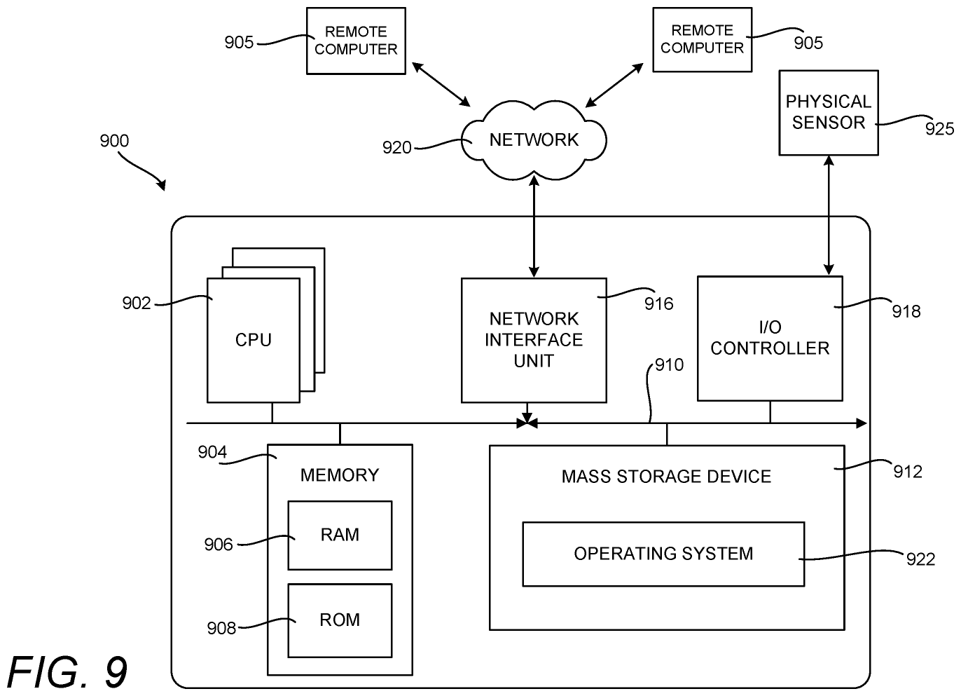

FIG. 9 is a computer architecture diagram showing an illustrative computer hardware and software architecture for a computing device 900 that can implement the various technologies presented herein. In particular, the architecture illustrated in FIG. 9 can be utilized to implement a server computer, mobile phone, an e-reader, a smailphone, a desktop computer, an AR/VR device, a tablet computer, a laptop computer, or another type of computing device. In some implementations, the client external devices 102 and computing devices 104 implement some or all of the elements and functionalities associated with the computing device 900.

The computer 900 illustrated in FIG. 9 includes a central processing unit 902 (“CPU”), a system memory 904, including a random-access memory 906 (“RAM”) and a read-only memory (“ROM”) 908, and a system bus 910 that couples the memory 904 to the CPU 902. A basic input/output system (“BIOS” or “firmware”) containing the basic routines that help to transfer information between elements within the computer 900, such as during startup, can be stored in the ROM 908. The computer 900 further includes a mass storage device 912 for storing an operating system 922, application programs, and other types of programs. The mass storage device 912 can also be configured to store other types of programs and data.

The mass storage device 912 is connected to the CPU 902 through a mass storage controller (not shown on FIG. 9) connected to the bus 910. The mass storage device 912 and its associated computer readable media provide non-volatile storage for the computer 900. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 900.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 900. For purposes of the claims, the phrase “computer storage medium,” and variations thereof, does not include waves or signals per se or communication media.

According to various configurations, the computer 900 can operate in a networked environment using logical connections to remote computers through a network such as the network 920. The computer 900 can connect to the network 920 through a network interface unit 916 connected to the bus 910. It should be appreciated that the network interface unit 916 can also be utilized to connect to other types of networks and remote computer systems. The computer 900 can also include an input/output controller 918 for receiving and processing input from a number of other devices, including a keyboard, mouse, touch input, an electronic stylus (not shown in FIG. 9), or a physical sensor such as a video camera. Similarly, the input/output controller 918 can provide output to a display screen or other type of output device (also not shown in FIG. 9).

It should be appreciated that the software components described herein, when loaded into the CPU 902 and executed, can transform the CPU 902 and the overall computer 900 from a general-purpose computing device into a special-purpose computing device customized to facilitate the functionality presented herein. The CPU 902 can be constructed from any number of transistors or other discrete circuit elements, which can individually or collectively assume any number of states. More specifically, the CPU 902 can operate as a finite-state machine, in response to executable instructions contained within the software modules disclosed herein. These computer-executable instructions can transform the CPU 902 by specifying how the CPU 902 transitions between states, thereby transforming the transistors or other discrete hardware elements constituting the CPU 902.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 900 in order to store and execute the software components presented herein. It also should be appreciated that the architecture shown in FIG. 9 for the computer 900, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 900 might not include all of the components shown in FIG. 9, can include other components that are not explicitly shown in FIG. 9, or can utilize an architecture completely different than that shown in FIG. 9.

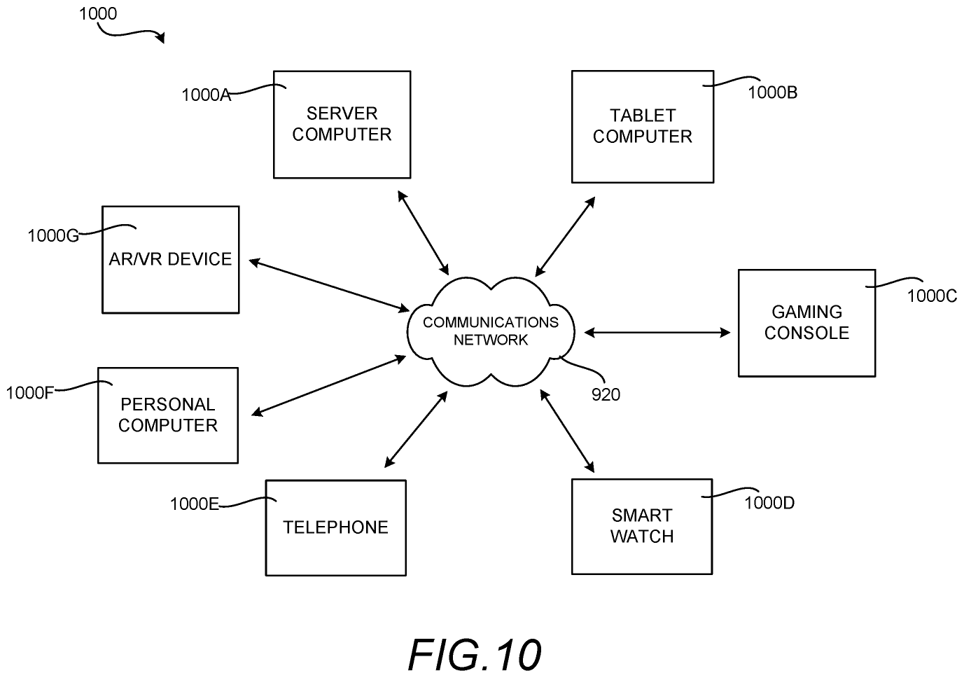

FIG. 10 is a network diagram illustrating a network computing environment 1000 in which aspects of the disclosed technologies can be implemented, according to various embodiments presented herein. The external device 102 and/or the computing device 104 may implement or couple to the distributed network computing environment 1000.

As shown in FIG. 10, one or more server computers 1000A can be interconnected via a communications network 920 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 1000B, a gaming console 1000C, a smart watch 1000D, a telephone 1000E, such as a smartphone, a personal computer 1000F, and an AR/VR device 1000G.

In a network environment in which the communications network 920 is the Internet, for example, the server computer 1000A can be a dedicated server computer operable to process and communicate data to and from the client computing devices 1000B-1000G via any of a number of known protocols, such as, hypertext transfer protocol (“HTTP”), file transfer protocol (“FTP”), or simple object access protocol (“SOAP”). Additionally, the networked computing environment 1000 can utilize various data security protocols such as secured socket layer (“SSL”) or pretty good privacy (“PGP”). Each of the client computing devices 1000B-1000G can be equipped with an operating system operable to support one or more computing applications or terminal sessions such as a web browser (not shown in FIG. 10), or other graphical user interface (not shown in FIG. 10), or a mobile desktop environment (not shown in FIG. 10) to gain access to the server computer 1000A.

The server computer 1000A can be communicatively coupled to other computing environments (not shown in FIG. 10) and receive data regarding a participating user's interactions/resource network. In an illustrative operation, a user (not shown in FIG. 10) may interact with a computing application running on a client computing device 1000B-1000G to obtain desired data and/or perform other computing applications.

The data and/or computing applications may be stored on the server 1000A, or servers 1000A, and communicated to cooperating users through the client computing devices 1000B-1000G over an exemplary communications network 920. A participating user (not shown in FIG. 10) may request access to specific data and applications housed in whole or in part on the server computer 1000A. These data may be communicated between the client computing devices 1000B-1000G and the server computer 1000A for processing and storage.

The server computer 1000A can host computing applications, processes and applets for the generation, authentication, encryption, and communication of data and applications, and may cooperate with other server computing environments (not shown in FIG. 10), third party service providers (not shown in FIG. 10), network attached storage (“NAS”) and storage area networks (“SAN”) to realize application/data transactions.

It should be appreciated that the computing architecture shown in FIG. 9 and the distributed network computing environment shown in FIG. 10 have been simplified for ease of discussion. It should also be appreciated that the computing architecture and the distributed computing network can include and utilize many more computing components, devices, software programs, networking devices, and other components not specifically described herein.

### EXAMPLE CLAUSES

The disclosure presented herein encompasses the subject matter set forth in the following clauses.

Clause 1. A computer implemented method to be performed by a voice over internet protocol (VoIP) application, the method comprising: detecting a direct communication channel between the VoIP communication application of a computing device and an external apparatus that supports VoIP communications; receiving, by the VoIP communication application, a first data message from the external apparatus, the first data message communicated over the direct communication channel and including data to cause the VoIP communication application to invoke at least one function supported by the VoIP communication application; analyzing, by the VoIP communication application, the data message to identify the at least one function supported by the VoIP communication application; executing, by the VoIP communication application, the at least one function; generating, by the VoIP communication application, a second data message with data linked to the at least one function executed by the VoIP communication application; and communicating, by the VoIP communication application, the second data message to the external apparatus over the direct communication channel.

Clause 2. The computer implemented method according to clause 1, further comprising: receiving a request message from the external apparatus comprising a request to establish the direct communication channel, the request message communicated by the external apparatus over a wireless or wireline communication interconnection between the external apparatus and a host computing device executing the VoIP communication application; in response to the request message, communicating a response message comprising a response approving the request to establish the direct communication channel, the response message communicated over the wireless or wireline communication interconnection between the external apparatus and the host computing device; and establishing the direct communication channel between the VoIP communication application and the external apparatus.

Clause 3. The computer implemented method according to clause 2, wherein the wireless or the wireline communication interconnection is a wireless Bluetooth interconnection between the external apparatus and the host computing device, and the direct communication channel between the VoIP communication application and the external apparatus is a Bluetooth channel associated with the Bluetooth interconnection and assigned to the VoIP communication application and the external apparatus.

Clause 4. The computer implemented method according to at least one of clauses 1-3, wherein the first data message includes a telephone number determined by the external apparatus by way of user input received by the external apparatus, and executing the at least one function comprises dialing the telephone number, by the VoIP communication application, and the second data message includes an acknowledgment message that the telephone number is being dialed by the VoIP communication application.

Clause 5. The computer implemented method according to at least one of clauses 1-4, wherein the VoIP communication application is implemented by a mobile telephone.

Clause 6. The computer implemented method according to at least one of clauses 1-5, wherein the second data message comprises caller identification data including at least one telephone number.

Clause 7. The computer implemented method according to at least one of clauses 1-6, further comprising generating a functions data message by the VoIP communication application comprising data identifying at least one function associated with the VoIP communication application, and communicating the functions data message to the external apparatus in advance of the VoIP communication application communicating the second data message to the external apparatus.

Clause 8. The computer implemented method according to clause 7, further comprising receiving, by the VoIP communication application, an acknowledgment message generated by the external apparatus in response to receiving the functions data message, the acknowledgment message comprising data confirming that the external apparatus supports the at least one function associated with the VoIP communication application.

Clause 9. A communication device supporting voice over internet protocol (VoIP) communications, comprising: a microphone; an indicator; and a controller programmed to: establish or confirm a direct communication channel between the communication device and a VoIP communication application hosted by a client computing device; generate a first data message, the first data message including data to cause the VoIP communication application to invoke at least one function supported by the VoIP communication application; communicate the first data message to the VoIP communication application over the direct communication channel; and in response to the first data message, receive a second data message from the VoIP communication application, the second data message received over the direct communication channel and including data linked to the at least one function supported by the VoIP communication application.

Clause 10. The communication device according to clause 9, wherein the controller is further programmed to: generate a request message comprising a request to establish the direct communication channel; communicate the request message over a wireless or wireline communication interconnection between the communication device and a host computing device executing the VoIP communication application; in response to the request message, receive a response message comprising a response approving the request to establish the direct communication channel, the response message communicated over the wireless or wireline communication interconnection between the communication device and the host computing device; and detect the direct communication channel between the VoIP communication application and the communication device.

Clause 11. The communication device according to clause 10, wherein the wireless or the wireline communication interconnection is a wireless Bluetooth interconnection between the communication device and the host computing device, and the direct communication channel between the VoIP communication application and the communication device is a Bluetooth channel associated with the Bluetooth interconnection and assigned to the VoIP communication application and the communication device.

Clause 12. The communication device according to at least one of clauses 9-11, wherein the first data message includes a telephone number determined by the communication device by way of user input received by the communication device, and the second data message includes an acknowledgment message that the telephone number is being dialed by the VoIP communication application.

Clause 13. The communication device according to at least one of clauses 9-12, wherein the communication device further comprises a speaker to convey sound associated with the VoIP communication application.

Clause 14. The communication device according to at least one of clauses 9-13, wherein the second data message comprises caller identification data including at least one telephone number.

Clause 15. The communication device according to at least one of clauses 9-14, wherein the controller is further programmed to receive a functions data message comprising data identifying at least one function associated with the VoIP communication application, the functions data message received in advance of the second data message.

Clause 16. The communication device according to clause 15, wherein the controller is further programmed to generate an acknowledgment message in response to receiving the functions data message, the acknowledgment message comprising data confirming that the communication device supports the at least one function associated with the VoIP communication application.

Clause 17. A computing device, comprising: means for detecting a direct communication channel between a voice over internet protocol (VoIP) communication application and an external apparatus that supports receiving communication data from the VoIP communication application; means for receiving a first data message from the external apparatus, the first data message communicated over the direct communication channel and including data to cause the VoIP communication application to invoke at least one function supported by the VoIP communication application; means for analyzing the data message to identify the at least one function supported by the VoIP communication application; means for executing, by the VoIP communication application, the at least one function; means for generating a second data message with data linked to the at least one function executed by the VoIP communication application; and means for communicating the second data message to the external apparatus over the direct communication channel.

Clause 18. The computing device according to clause 17, further comprising: means for receiving a request message from the external apparatus comprising a request to establish the direct communication channel, the request message communicated by the external apparatus over a wireless or wireline communication interconnection between the external apparatus and the computing device; means for communicating a response message comprising a response approving the request to establish the direct communication channel in response to the request message, the response message communicated over the wireless or wireline communication interconnection between the external apparatus and the computing device; and means for establishing the direct communication channel between the VoIP communication application and the external apparatus.

Clause 19. The computing device according to clause 18, wherein the wireless communication interconnection is a wireless Bluetooth interconnection between the external apparatus and the computing device, and the direct communication channel between the VoIP communication application and the external apparatus is a Bluetooth channel associated with the Bluetooth interconnection and assigned to the VoIP communication application and the external apparatus.

Clause 20. The computing device according to at least one of clauses 17-19, wherein the first data message includes a telephone number determined by the external apparatus by way of user input received by the external apparatus, executing the at least one function comprises dialing the telephone number, by the VoIP communication application, and the second data message includes an acknowledgment message that the telephone number is being dialed by the VoIP communication application.

Although the techniques have been described in language specific to structural features and/or methodological acts, it is to be understood that the appended claims are not necessarily limited to the features or acts described. Rather, the features and acts are described as example implementations of such techniques.

It should be appreciated that the above-described subject matter may be implemented as a computer-controlled apparatus, a computer process, a computing system, or as an article of manufacture such as a computer-readable storage medium. Among many other benefits, the techniques herein improve efficiencies with respect to a wide range of computing resources. For instance, human interaction with a devices and systems may be improved as the use of the techniques disclosed herein enable users and individuals remotely manipulate rendered streams within a graphical environment associated with a communication session to better reflect their interactions in the communication session. Other technical effects other than those mentioned herein can also be realized from implementations of the technologies disclosed herein.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A computer implemented method to be performed by a voice over internet protocol (VoIP) application, the method comprising:
detecting a direct communication channel between the VoIP communication application of a computing device and an external apparatus that supports VoIP communications;
receiving, by the VoIP communication application, a first data message from the external apparatus, the first data message communicated over the direct communication channel and including data to cause the VoIP communication application to invoke at least one function supported by the VoIP communication application;
analyzing, by the VoIP communication application, the data message to identify the at least one function supported by the VoIP communication application;
executing, by the VoIP communication application, the at least one function;
generating, by the VoIP communication application, a second data message with data linked to the at least one function executed by the VoIP communication application; and
communicating, by the VoIP communication application, the second data message to the external apparatus over the direct communication channel.

2. The computer implemented method according to claim 1, further comprising:
receiving a request message from the external apparatus comprising a request to establish the direct communication channel, the request message communicated by the external apparatus over a wireless or wireline communication interconnection between the external apparatus and a host computing device executing the VoIP communication application;
in response to the request message, communicating a response message comprising a response approving the request to establish the direct communication channel, the response message communicated over the wireless or wireline communication interconnection between the external apparatus and the host computing device; and
establishing the direct communication channel between the VoIP communication application and the external apparatus.

3. The computer implemented method according to claim 2, wherein the wireless or the wireline communication interconnection is a wireless Bluetooth interconnection between the external apparatus and the host computing device, and the direct communication channel between the VoIP communication application and the external apparatus is a Bluetooth channel associated with the Bluetooth interconnection and assigned to the VoIP communication application and the external apparatus.

4. The computer implemented method according to claim 1, wherein the first data message includes a telephone number determined by the external apparatus by way of user input received by the external apparatus, and executing the at least one function comprises dialing the telephone number, by the VoIP communication application, and the second data message includes an acknowledgment message that the telephone number is being dialed by the VoIP communication application.

5. The computer implemented method according to claim 1, wherein the VoIP communication application is implemented by a mobile telephone.

6. The computer implemented method according to claim 1, wherein the second data message comprises caller identification data including at least one telephone number.

7. The computer implemented method according to claim 1, further comprising generating a functions data message by the VoIP communication application comprising data identifying at least one function associated with the VoIP communication application, and communicating the functions data message to the external apparatus in advance of the VoIP communication application communicating the second data message to the external apparatus.

8. The computer implemented method according to claim 7, further comprising receiving, by the VoIP communication application, an acknowledgment message generated by the external apparatus in response to receiving the functions data message, the acknowledgment message comprising data confirming that the external apparatus supports the at least one function associated with the VoIP communication application.

9. A communication device supporting voice over internet protocol (VoIP) communications, comprising:
a microphone;
an indicator; and
a controller programmed to:
establish or confirm a direct communication channel between the communication device and a VoIP communication application hosted by a client computing device;
generate a first data message, the first data message including data to cause the VoIP communication application to invoke at least one function supported by the VoIP communication application;
communicate the first data message to the VoIP communication application over the direct communication channel; and
in response to the first data message, receive a second data message from the VoIP communication application, the second data message received over the direct communication channel and including data linked to the at least one function supported by the VoIP communication application.

10. The communication device according to claim 9, wherein the controller is further programmed to:
generate a request message comprising a request to establish the direct communication channel;
communicate the request message over a wireless or wireline communication interconnection between the communication device and a host computing device executing the VoIP communication application;
in response to the request message, receive a response message comprising a response approving the request to establish the direct communication channel, the response message communicated over the wireless or wireline communication interconnection between the communication device and the host computing device; and
detect the direct communication channel between the VoIP communication application and the communication device.

11. The communication device according to claim 10, wherein the wireless or the wireline communication interconnection is a wireless Bluetooth interconnection between the communication device and the host computing device, and the direct communication channel between the VoIP communication application and the communication device is a Bluetooth channel associated with the Bluetooth interconnection and assigned to the VoIP communication application and the communication device.

12. The communication device according to claim 9, wherein the first data message includes a telephone number determined by the communication device by way of user input received by the communication device, and the second data message includes an acknowledgment message that the telephone number is being dialed by the VoIP communication application.

13. The communication device according to claim 9, wherein the communication device further comprises a speaker to convey sound associated with the VoIP communication application.

14. The communication device according to claim 9, wherein the second data message comprises caller identification data including at least one telephone number.

15. The communication device according to claim 9, wherein the controller is further programmed to receive a functions data message comprising data identifying at least one function associated with the VoIP communication application, the functions data message received in advance of the second data message.

16. The communication device according to claim 15, wherein the controller is further programmed to generate an acknowledgment message in response to receiving the functions data message, the acknowledgment message comprising data confirming that the communication device supports the at least one function associated with the VoIP communication application.

17. A computing device, comprising:
means for detecting a direct communication channel between a voice over internet protocol (VoIP) communication application and an external apparatus that supports receiving communication data from the VoIP communication application;
means for receiving a first data message from the external apparatus, the first data message communicated over the direct communication channel and including data to cause the VoIP communication application to invoke at least one function supported by the VoIP communication application;
means for analyzing the data message to identify the at least one function supported by the VoIP communication application;
means for executing, by the VoIP communication application, the at least one function;
means for generating a second data message with data linked to the at least one function executed by the VoIP communication application; and
means for communicating the second data message to the external apparatus over the direct communication channel.

18. The computing device according to claim 17, further comprising:
means for receiving a request message from the external apparatus comprising a request to establish the direct communication channel, the request message communicated by the external apparatus over a wireless or wireline communication interconnection between the external apparatus and the computing device;
means for communicating a response message comprising a response approving the request to establish the direct communication channel in response to the request message, the response message communicated over the wireless or wireline communication interconnection between the external apparatus and the computing device; and
means for establishing the direct communication channel between the VoIP communication application and the external apparatus.

19. The computing device according to claim 18, wherein the wireless communication interconnection is a wireless Bluetooth interconnection between the external apparatus and the computing device, and the direct communication channel between the VoIP communication application and the external apparatus is a Bluetooth channel associated with the Bluetooth interconnection and assigned to the VoIP communication application and the external apparatus.

20. The computing device according to claim 17, wherein the first data message includes a telephone number determined by the external apparatus by way of user input received by the external apparatus, executing the at least one function comprises dialing the telephone number, by the VoIP communication application, and the second data message includes an acknowledgment message that the telephone number is being dialed by the VoIP communication application.
